(19) United States
(12) Patent Application Publication
(10) Pub. No.: US 2007/0245343 A1
(43) Pub. Date: Oct. 18, 2007

(54) System and Method of Blocking Keyloggers

(76) Inventors: Marvin Shannon, (US); Wesley Boudville, (US)

Correspondence Address: MARVIN SHANNON, 3579 EAST FOOTHILL BLVD, #328, PASADENA, CA, 91107, US

(21) Appl. No.: 11/616,927

(22) Filed: Dec. 28, 2006

Related U.S. Application Data
(60) Provisional application No. 60/766,111, filed on Dec. 30, 2005.

(51) Int. Cl. G06F 9/445

(52) U.S. Cl. 717/174

(57) ABSTRACT

We attack software keylogging in a user's computer. We use a device driver (“Phlog”) that sits as close to the hardware controller as possible. It interacts with an antiphishing plug-in to a browser, that was described in our earlier inventions. When the plug-in validates a web page with a Notphish tag and a special field, then it contacts Phlog and has Phlog send it directly the key clicks. Bypassing any keylogging listening for those clicks. Our method can also be used against malware using mouse clicks as triggers for screen scraping.

### CROSS-REFERENCES TO RELATED APPLICATIONS

This application claims the benefit of the filing date of U.S. Provisional Application, No. 60/766111, “System and Method of Blocking Keyloggers”, filed December 30, 2005. That Application is incorporated by reference in its entirety.

### REFERENCES CITED

“Rootkits: Subverting the Windows Kernel” by G Hoglund and J Butler, Addison-Wesley 2005.

### TECHNICAL FIELD

This invention relates generally to information delivery and management in a computer network. More particularly, the invention relates to techniques for attacking keyloggers that harvest a user's key clicks or mouse clicks.

### BACKGROUND OF THE INVENTION

As viruses, worms, pharming and other malware have proliferated, one type has proved very effective in obtaining users' personal information. This is a keylogger. It can be implemented either as hardware or software. The hardware form usually consists of a gadget that is plugged between the keyboard and the computer. It logs the key clicks. And at some future time, the person who installed it retrieves it and downloads the key clicks. From these, she tries to determine usernames and passwords at various websites, of the people who have used the keyboard. However, the gadget suffers from the defect that physical access is needed to the keyboard.

More dangerous is the software keylogger. Methods against which are the subject of this Invention. Henceforth, when we use the term keylogger, we refer to the software variant. It is more dangerous because it can be remotely installed on many computers. The remote installation might be due to some bug in the operating system of a computer, or in a third party application running on that computer. It might also involve fooling the user, perhaps into downloading a presumably innocuous program, that turns out to be the keylogger.

The keylogger records key clicks. Then, after some interval, it uploads these to another computer on the network, where the network is typically the Internet. It can be appreciated that not only can the keylogger be installed on many machines, but that the remote reporting lets the author of the code be anywhere in the world, and specifically outside the jurisdictions of many of the users' governments.

Keylogging can be especially dangerous when users are logging into their bank or financial websites. In response, some banks have gravitated towards the use of a virtual keyboard. They make a web page that has an image of a keyboard. Then, the user enters her password not by key clicks, but by mouse clicks on the appropriate parts of the image, that correspond to the letters or digits in her password.

In turn, this has elicited the following response by some malware authors. A screen scraper malware program is covertly installed, by the means discussed above. This might be triggered by a mouse click, and takes an image (“screen scrape”) of the browser window, or of the entire screen. Hence, the image would show the position of the mouse on a particular letter or digit, when it is clicked. The images could then be periodically uploaded to a remote network address.

### SUMMARY OF THE INVENTION

The foregoing has outlined some of the more pertinent objects and features of the present invention. These objects and features should be construed to be merely illustrative of some of the more prominent features and applications of the invention. Other beneficial results can be achieved by using the disclosed invention in a different manner or changing the invention as will be described. Thus, other objects and a fuller understanding of the invention may be had by referring to the following detailed description of the Preferred Embodiment.

We attack software keylogging in a user's computer. We use a device driver (“Phlog”) that sits as close to the hardware controller as possible. It interacts with an antiphishing plug-in to a browser, that was described in our earlier inventions. When the plug-in validates a web page with a Notphish tag and a special field, then it contacts Phlog and has Phlog send it directly the key clicks. Bypassing any keylogging listening for those clicks. Our method can also be used against malware using mouse clicks as triggers for screen scraping.

### BRIEF DESCRIPTION OF THE DRAWINGS

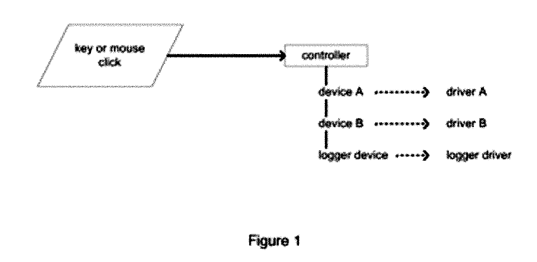

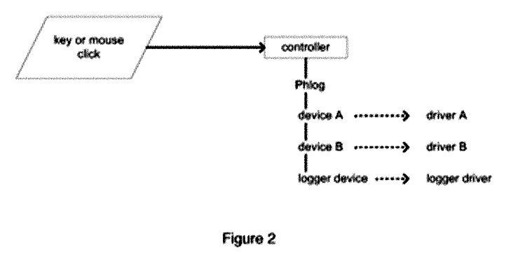

There are two drawings. FIG. 1 shows how key or mouse clicks are typically processed by a computer. FIG. 2 shows our modification, designated by the item “Phlog”.

For a more complete understanding of the present invention and the advantages thereof, reference should be made to the following Detailed Description taken in connection with the accompanying drawing.

### DETAILED DESCRIPTION OF THE PREFERRED EMBODIMENT

What we claim as new and desire to secure by letters patent is set forth in the following claims.

We have described many ways, using an Aggregation Center (Agg) in conjunction with a browser plug-in, to detect phishing and pharming in these U.S. Provisional Patents:

#60/522245 (“2245”), “System and Method to Detect Phishing and Verify Electronic Advertising”, Sep. 7, 2004; #60/522458 (“2458”), “System and Method for Enhanced Detection of Phishing”, Oct. 4, 2004; #60/552528 (“2528”), “System and Method for Finding Message Bodies in Web-Displayed Messaging”, Oct. 11, 2004; #60/552640 (“2640”), “System and Method for For Investigating Phishing Web Sites”, Oct. 22, 2004; #60/552644 (“2644”), “System and Method for Detecting Phishing Messages In Sparse Data Communications”, Oct. 24, 2004; #60/593114 (“3114”), “System and Method of Blocking Pornographic Websites and Content”, Dec. 12, 2004; #60/593115 (“3115”), “System and Method for Attacking Malware in Electronic Messages”, Dec. 12, 2004; #60/593186 (“3186”), “System and Method for Making a Validated Search Engine”, Dec. 18, 2004; #60/593877 (“3877”), “System and Method for Improving Multiple Two Factor Usage”, Feb. 21, 2005; #60/593878 (“3878”), “System and Method for Registered and Authenticated Electronic Messages”, Feb. 21, 2005; #60/593879 (“3879”), “System and Method of Mobile Anti-Pharming”, Feb. 21, 2005; #60/594043 (“4043”), “System and Method for Upgrading an Anonymizer for Mobile Anti-Pharming”, Mar. 7, 2005; #60/594051 (“4051”), “System and Method for Using a Browser Plug-in to Combat Click Fraud”, Mar. 7, 2005; #60/595804 (“5804”), “System and Method for an Anti-Phishing Plug-in to Aid e-Commerce”, Aug. 7, 2005; #60/595809, (“5809”), “System and Method of Anti Spear Phishing and Anti-Pharming”, Aug. 7, 2005.

Collectively, we shall refer to these as the “Antiphishing Provisionals”.

Our method is a simple extension of these Provisionals. Most operating systems have the following arrangement, for what happens when a user clicks a key or a mouse button; as in FIG. 1. (Cf. “Rootkits: Subverting the Windows Kernel” by Hoglund and Butler, Addison-Wesley 2005, p. 135).

Here, for simplicity, we have drawn the key and mouse clicks as going to the same controller. In general, they go to different controllers. But the modification of our method to handle this case is straightforward. The “devices” in the above are software constructs, and the controller is a piece of hardware. We have shown two devices, and their drivers, hooked up to the controller, and well as a malware logger. The two devices are assumed to be normal, non-malware processes that wish to process the clicks. In general, there might be more than two such devices. Specifically, one of these device drivers is connected to the window manager. The window manager mediates between windows. It decides which window or windows can get the click information.

Our method involves the use of a program (“Phlog”). It might function as a virtual (i.e. software) device driver, as shown in FIG. 2.

In general, Phlog should sit as far upstream as possible. To reduce the risk that the logger might be upstream of it. To this ends, one possible implementation of Phlog might be to incorporate it into the hardware controller. Though in our discussion here we will consider the two to be separate, in a preferred implementation.

Our Invention is independent of the operating system of the computer. However, for personal computers, the market reality is that about 90% of these run a Microsoft Corp.'s operating system. Under most current versions of those operating systems, Phlog would need to be installed in kernel mode, not user mode. Equivalently, Phlog runs in Ring 0, when the operating system is using an Intel microprocessor. For other operating systems, Phlog would be installed in the system (=kernel) mode, or whatever is the equivalent term used for those operating systems. This should not be a problem, inasmuch as Phlog is meant to be explicitly installed by a sysadmin, or it comes with the operating system. Malware, on the other hand, would like be installed in system space, for more privileges. But often, aside from bugs in the operating system or social engineering, malware often has to run in user space.

Phlog operates in conjunction with a special plug-in in the browser. There is a direct, interprocess communication between the two programs. If the plug-in does not exist, then Phlog can simply operate by passing received data from the hardware device driver to the window manager. In a preferred implementation, we shall assume that the plug-in does exist.

When Phlog gets a signal from the plug-in, it can do several things. It can send all subsequent clicks directly to the plug-in. Until perhaps instructed otherwise by the plug-in. The logger never gets the clicks.

Alternatively, instead of sending nothing to the other drivers, Phlog can send false information. For example, a false username and password. Especially if this is for logging into a financial website. This information can be used by that website. When it receives a later login, presumably from another computer, with those false values, then it can apply intensive investigations. This gives the website an active, aggressive weapon against malware authors. Plus, if the website records which computer's Phlog or plug-in told it of that false information, it can in turn alert the computer's owner, saying that the computer might have a logger.

A merit of this idea is that the method might be publicised, to deter an attacker. Even if only a few percent of the data that she obtains from her logger are false in the above manner, she does not know which data are false. Which makes it harder for her to utilize the entire data set.

The choice of what Phlog does can be advised by values within the signal. Phlog might have logic to actually determine the choice of action.

So when does the plug-in ask Phlog to directly send it data, and, later, to stop sending it data? The plug-in can have various heuristics to make these decisions. For example, it might inspect the URL or URI that the browser is at. If this belongs to a list of financial companies that it has, for example, then it might ask Phlog to send it data directly. And when the browser moves outside this list, then it asks Phlog to stop doing so.

Another heuristic is that if the browser is using a secure protocol, like https or sftp, then the plug-in might ask Phlog to directly send it data. And when the browser is not using such a protocol, then the plug-in asks Phlog to stop directly sending it data.

The problem is that the heuristics are somewhat subjective. They are essentially estimates of general cases that might need protecting against loggers. But within these cases, some or even most pages might not not need such protection. And outside these cases, there might be other instances where protection is desired by the pages' authors.

Another (and better) choice for the plug-in action is possible. The page being viewed by a browser could have a tag, different from the standard HTML tags, and different from non-HTML tags that are commonly used, e.g. for pages optimized for Internet Explorer. Within these constraints, the name of the tag is arbitrary. When the plug-in detects a page with the tag, it asks Phlog to directly send it data. When the browser goes to a page without the tag, then the plug-in can ask Phlog to stop sending it data. This offers far more precision than using a heuristic to guess if a page should be protected in this fashion. This choice is objective, for it lets the page or message author decide what is to be protected.

A preferred implementation of the tag involves the use of the Notphish tag in “2458”, in conjunction with an Aggregator. Thus, there might be an field in the tag, called “phlog”, as shown here:
<notphish a=“bank0.com” phlog/>

This tag claims that the page (or message) came from bank0.com, and that the plug-in should ask Phlog to directly send it data. The plug-in can use the value of the address field to ask an Aggregator for data for bank0.com, as described in “2458”. (In the above tag example, other fields are possible.) The Aggregator can tell the plug-in if bank0.com is one of its validated customers. If so, then the plug-in does various analysis of the page or message, and compares this with data from the Aggregator. For example, it might find the links in the page or message, and derive the base domains from these and ascertain if all these are in the Partner List for that customer, as described in “2245”, “2458” and “2528”. If there is a domain outside this list, then the page or message can be considered to be phishing, and the user is alerted by the plug-in. Here, Phlog is not involved.

But, suppose the page or message passes the plug-in's analysis. It might be considered authentic. The plug-in asks Phlog to exclusively send it the mouse or key clicks. The plug-in then sends these to the page or message.

By having the plug-in check with the Aggregator, our Invention reduces the risk that an arbitrary website or message writes such a tag with the phlog value, to try to perform possible mischief by bypassing the window manager.

The company, bank0.com in this example, can write the above tag for those crucial web pages where its users are logging in. One variant is that the tag, or the settings for the page that bank0 uploads to the Aggregator, can indicate whether it is the key clicks only, the mouse clicks only, or both types of clicks, that should be routed directly and exclusively from Phlog to the plug-in. Of course, if the tag has such a notation, then it should be checked with the settings downloaded from the Aggregator.

Now suppose the user is at such a page, and the clicks are going directly from Phlog to the plug-in. This can stop happening when the plug-in detects a page without the Notphish tag, or without the phlog value in the tag. The plug-in tells Phlog to resume its normal pass-through operation.

This Invention extends the capability of the Notphish tag and Aggregator. Earlier Provisionals used those to let a plug-in detect a fake message (phishing) or website (pharming). But now, given a real message or website, we extend those methods to protect against a covert logger. It is backwardly compatible with existing browser usage and web pages.

Extensions

Various extensions are possible. For example, some banks (or other companies) might put up a login web page, where images are displayed, and the user has to click on a correct image. Here, the image functions as an equivalent to a text password. Similarly, an attacker might have a logger triggered by a mouse click, to scrape the screen when the user clicks on an image. Hence, our Invention can also act in the manner above, to block such logging.

The above discussed when the page or message author used a Notphish tag and a Phlog field to designate protection. This can also be combined with settings on the user's computer, that she can adjust. These settings might also apply this method, for certain pages or messages lacking the tag and field. Or they might not apply this method, for certain pages or messages with the tag and field. Though we suggest that in practice, most users will not use (or even understand) any such abilities.

How does a Phlog and a plug-in ascertain that the other is valid? They might use some type of zero knowledge protocol to verify each other. Or, each might compute a hash of the other's binary. Then it compares this computed hash against a table of known correct hashes. This table might be gotten from the Aggregator. Perhaps in conjunction with each program having a hardwired set of hashes of its counterpart. This validating of each other might be done when the browser starts up, for example. It typically takes several seconds, within which there should be enough time for validation.

But suppose somehow that Phlog is a fake and the plug-in is real and the plug-in cannot tell that Phlog is a fake. As far as logging is concerned, this is no worse than a situation where a real Phlog is not present. The plug-in does not give the fake Phlog any more information about the user's actions than what Phlog can already directly get from the machine.

We discussed blocking of keyboard or mouse input. But consider the case of a company with a web page containing sensitive data. Maybe it is shown to the user only after the user has logged in. And the page is shown with https, say, to prevent an evesdropper from seeing the page. Imagine where the user does not enter any information on the page, other than perhaps to click on links. The company might want to reduce the risk of the page image being scraped by malware on the user's computer. Our method can be used for this, to prevent scraping being triggered by a click.

But what if the scraping is being done by a process not triggered by a click? One countermeasure is to have Phlog prevent any process from doing a screen or window capture, when the plug-in sees a validated page with a Notphish tag and a phlog field.

We have discussed the keyboard and mouse. Our method also applies to other input devices, including, but not limited to, a data glove, joystick, or a heads-up display device with user feedback.

Our method can also be extended to an input device that is a microphone. Imagine that the user is using a browser or some other application that communicates over a network to bank0.com. The latter might have some procedure, perhaps for logging in, where the user speaks. Just as for the above clandestine loggers, there might also be a malware logger that records the spoken input. Hence, our method can have the bank0 message contain a Notphish tag with a phlog field. Then, the user application has the equivalent of the browser plug-in, which reads this tag. Upon verification of the message and tag with the Aggregator, the plug-in tells a Phlog to direct the audio input exclusively to it. Here, this Phlog is a device driver that gets the audio input, as close to the audio hardware as possible. (Or even being part of the hardware.)

Along these lines, there might a Phlog that intercepts the audio output. Normally, it just passes the output to the next driver in this output chain. But it might also be able to exclusively send data directly to the audio output hardware, bypassing any other drivers that request a copy of the data. This Phlog might act, based on signals from a plug-in, in the manner described above.

What is claimed is:

1. A method where a custom software device driver (“Phlog”), for processing key or mouse clicks, is installed to be the sole recipient of these clicks from the hardware controller of a computer, and where Phlog makes decisions on whether to pass these clicks onto various downstream device drivers.

2. A method, using claim 1, where Phlog and a custom browser plug-in can communicate, and where the plug-in can ask Phlog to exclusively send it the clicks.

3. A method, using claim 2, where the plug-in makes this decision upon parsing a web page and finding a custom tag or attribute that instructs it to do so, and where the plug-in first verifies that page and its properties against data from a central web site (“Agg”).

4. A method, using claim 2, where the plug-in makes this decision based on heuristics about the page, without recourse to a central web site.

5. A method, using claim 3, where Phlog sends false information downstream to any device drivers, while routing the true clickstream to the plug-in.

6. A method where Phlog controls access to the screen and window information held in memory, and can prevent a software process from taking an image capture, perhaps based on instructions from the plug-in.
